(19) United States
(12) Patent Application Publication
(10) Pub. No.: US 2024/0387088 A1
(43) Pub. Date: Nov. 21, 2024

(54) ELECTROMAGNETIC BED

(71) Applicant: Taicang Manaflex Technology Co., Ltd., Taicang City (CN)

(72) Inventors: Robert C. LANE, Las Vegas, NV (US); Yi QIN, Jiangsu (CN); Yifei LIU, Toronto (CA)

(21) Appl. No.: 18/669,900

(22) Filed: May 21, 2024

Related U.S. Application Data
(63) Continuation-in-part of application No. 18/522,941, filed on Nov. 29, 2023.

(30) Foreign Application Priority Data
Nov. 30, 2022 (CN) 202223212705.9

(51) Int. Cl. H01F 7/20

(52) U.S. Cl. CPC H01F 7/206; H01F 2007/208

(57) ABSTRACT

An electromagnetic bed for a workpiece includes an electromagnetic bed body having a top surface that includes magnetic blocks arranged in a rectangular array, at least one of the magnetic blocks has a positioning pin protruding from the second top surface, the at least one of the magnetic blocks being fixed in the electromagnetic bed body by a bolt, a bottom plate placed proximate to the second top surfaces, and a cover plate is arranged correspondingly with the electromagnetic bed body, the cover plate being made of a magnetic material, with the workpiece placed between the bottom plate and the cover plate.

### CROSS REFERENCE TO RELATED APPLICATIONS

This application is a continuation-in-part application of U.S. patent application Ser. No. 18/522,941 filed on Nov. 29, 2023, entitled “Electromagnetic Bed,” which claims priority under 35 U.S.C. § 119 to Chinese Utility Model Application No. 202223212705.9 filed on Nov. 30, 2022. The disclosure of each of the above-identified two patent applications is hereby incorporated by reference in its entirety for all purposes.

### TECHNICAL FIELD

The present disclosure relates to the technical field of welding processing, and in particular, to an electromagnetic bed.

### BACKGROUND

Electronically controlled permanent magnet chuck (also known as disk or electromagnetic bed chuck, etc.) is a new type of fixture designed and developed by combining electromagnetic and permanent magnet characteristics. The suction is very safe and reliable in the process of holding the workpiece, after holding the workpiece with magnetic force, the suction will maintain magnetic suction indefinitely, but the electronically controlled permanent magnet can only hold workpieces made of magnetic materials (materials that can be held by magnets, such as: Iron, cobalt, nickel, etc.). Non-magnetic materials (stainless steel, copper, aluminum, etc.) cannot hold, especially like the electronics industry, copper or aluminum and other conductors, cannot directly hold, and, copper or aluminum and other conductors are mostly thin or thin sheet structure, small workpieces, conventional mechanical or pneumatic hard fixed clamping method. The gap between the mechanical structure will cause error or excessive compression resulting in indentation or damage, etc., in the process of processing also need to avoid the position of the clamp, increase the difficulty of processing. Therefore, improvements need to be made.

### SUMMARY

The present disclosure relates to an electromagnetic bed that overcomes the shortcomings in the prior technology.

In one aspect of the present disclosure, an electromagnetic bed for a workpiece comprises an electromagnetic bed body that is arranged horizontally, the electromagnetic bed body having a first top surface that includes magnetic blocks that are arranged in a rectangular array, at least one of the magnetic blocks has a second top surface that has a concave sink hole and a positioning pin protruding from the second top surface, the at least one of the magnetic blocks being fixed in the electromagnetic bed body by a bolt, and a cover plate is arranged correspondingly with the electromagnetic bed body, the cover plate being made of a magnetic material, wherein the workpiece can be placed between the electromagnetic bed body and the cover plate.

In one embodiment, the at least one of the magnetic blocks has a rectangular structure, the electromagnetic bed body is provided with a plurality of installation slots, and a bottom of each of the plurality of installation slots is provided with a plurality of threaded holes that correspond to a magnetic block located therein.

In another embodiment, each of the magnetic blocks has a chamfered edge. In another embodiment, each positioning pin is placed into a hole in one of the magnetic blocks. In yet another embodiment, at least one side of the cover plate is held at its circumferential surface by one of the positioning pins. In an alternative embodiment, the cover plate is arranged so that a positioning pin extends into a hole in the cover plate. In another alternative embodiment, a positioning bar is located on a side of the cover plate or a side of the workpiece, and the positioning bar is provided with a positioning hole that can receive a positioning pin.

In another aspect of the present disclosure, an electromagnetic bed for a workpiece comprises an electromagnetic bed body having a top surface that includes a plurality of magnetic blocks, each of the plurality of magnetic blocks has its own top surface that has a positioning pin protruding therefrom, each of the plurality of magnetic blocks being coupled to the electromagnetic bed body, and a cover plate that can be positioned proximate to the top surface of the electromagnetic bed body, and the cover plate being made of a magnetic material, wherein the workpiece can be placed between the electromagnetic bed body and the cover plate.

In one embodiment, the electromagnetic bed body has a plurality of installation slots, each of the plurality of installation slots receiving at least one magnetic block, and a bottom of each of the plurality of installation slots has at least one hole that corresponds to a magnetic block located therein and that can be used to couple a magnetic body to the electromagnetic bed body.

In another embodiment, each of the plurality of installation slots receives four magnetic blocks. In yet another embodiment, each of the plurality of magnetic blocks has a chamfered edge. In an alternative embodiment, the top surface of each of the plurality of magnetic blocks has a hole, and each positioning pin is placed into the hole in the top surface of each of the plurality of magnetic blocks.

In yet another embodiment, at least one side of the cover plate is held at its circumferential surface by one of the positioning pins. In another embodiment, the cover plate is arranged so that a positioning pin extends into a hole in the cover plate. In an alternative embodiment, a positioning bar is located on a side of the cover plate or a side of the workpiece, and the positioning bar is provided with a positioning hole that can receive a positioning pin.

In another aspect of the present invention, an electromagnetic bed for a workpiece comprises an electromagnetic bed body having a top surface that includes a plurality of magnetic blocks, the electromagnetic bed body has a plurality of installation slots, each of the plurality of installation slots receiving at least one magnetic block, each of the plurality of magnetic blocks has its own top surface that has a positioning pin protruding therefrom, each of the plurality of magnetic blocks being coupled to the electromagnetic bed body, and a cover plate that can be positioned proximate to the top surface of the electromagnetic bed body, and the cover plate being made of a magnetic material, wherein the workpiece can be placed between the electromagnetic bed body and the cover plate, and the cover plate is drawn to the electromagnetic bed body to hold the workpiece in place.

In another embodiment, a bottom of each of the plurality of installation slots has at least one hole that corresponds to a magnetic block located therein and that can be used to couple one of the plurality of magnetic blocks to the electromagnetic bed body. In yet another embodiment, each of the plurality of installation slots receives four magnetic blocks. In another embodiment, the top surface of each of the plurality of magnetic blocks has a hole, and each positioning pin is placed into the hole in the top surface of each of the plurality of magnetic blocks. In yet another embodiment, at least one side of the cover plate is held at its circumferential surface by one of the positioning pins.

Compared with the prior technology, the present disclosure has the advantages of a simple structure, which is used for fixing non-magnetic and thin workpieces when welding, and the surface contact between the electromagnetic bed body and the cover plate and the workpiece can fix the whole plate of the workpiece at the same time and improve the work efficiency.

### BRIEF DESCRIPTION OF THE DRAWINGS

In order to more clearly explain the technical aspects of this disclosure, the following is a list of the drawings used in the description. The drawings described below are only some implementations relating to this disclosure. The drawings form an integral part of the description and illustrate embodiments of the present application, which should not be interpreted as restricting the scope of the invention, but just as examples. The drawings comprise the following figures:

FIG. 1 illustrates a top perspective view of an embodiment of an electromagnetic bed according to the present disclosure.

FIG. 2 illustrates a bottom perspective view of the electromagnetic bed body illustrated in FIG. 1.

FIG. 3 illustrates another top perspective view of the electromagnetic bed body illustrated in FIG. 1.

FIG. 4 illustrates a close-up view of a portion of the electromagnetic bed body illustrated in FIG. 1 showing a few magnetic conductive blocks.

FIG. 5 illustrates another close-up view of the portion of the electromagnetic bed body illustrated in FIG. 1 showing a few magnetic conductive blocks.

FIG. 6 illustrates a perspective view of a workpiece according to the present disclosure.

FIG. 7 illustrates an exploded perspective view of an alternative embodiment of an electromagnetic bed according to the present disclosure with an exemplary workpiece.

FIG. 8 illustrates a perspective view of the electromagnetic bed illustrated in FIG. 7 holding a workpiece.

FIG. 9 illustrates a plan view of the electromagnetic bed illustrated in FIG. 7.

Like reference numerals have been used to identify like elements throughout this disclosure.

### DETAILED DESCRIPTION

The following is a detailed description of the technical aspects of the present disclosure in combination with the drawings. Obviously, the described implementation is only a part of the implementation of this disclosure, but not all of the implementations. Based on the implementations herein, all other implementations obtained by ordinary technical personnel in the field are contemplated herein.

In the description herein, any orientation or position relationship indicated by the terms “center”, “up”, “down”, “left”, “right”, “vertical”, “horizontal”, “inside”, “outside”, etc. is based on the orientation or position relationship shown in the drawings, and is intended only for the purpose of facilitating and simplifying the description. Rather than indicating or implying that the device or element referred to must have a specific orientation, structure or operation in a specific orientation, the relative orientation or position relationship is not so limited. In addition, the terms “first”, “second” and “third” are used only for descriptive purposes and should not be interpreted as limiting or as suggesting relative importance.

In the description herein, it needs to be noted that, unless otherwise expressly specified and limited, the terms “installation” and “connection” shall be broadly understood, for example, and can be a fixed connection, a detachable connection, or a single connection. Also, it can be a mechanical connection or an electrical connection, and it can be directly connected, or indirectly connected through an intermediate medium or component. Alternatively, it can be a connection with two components. For ordinary technical personnel in the field, the specific meaning of the above terms in the description can be understood in specific circumstances.

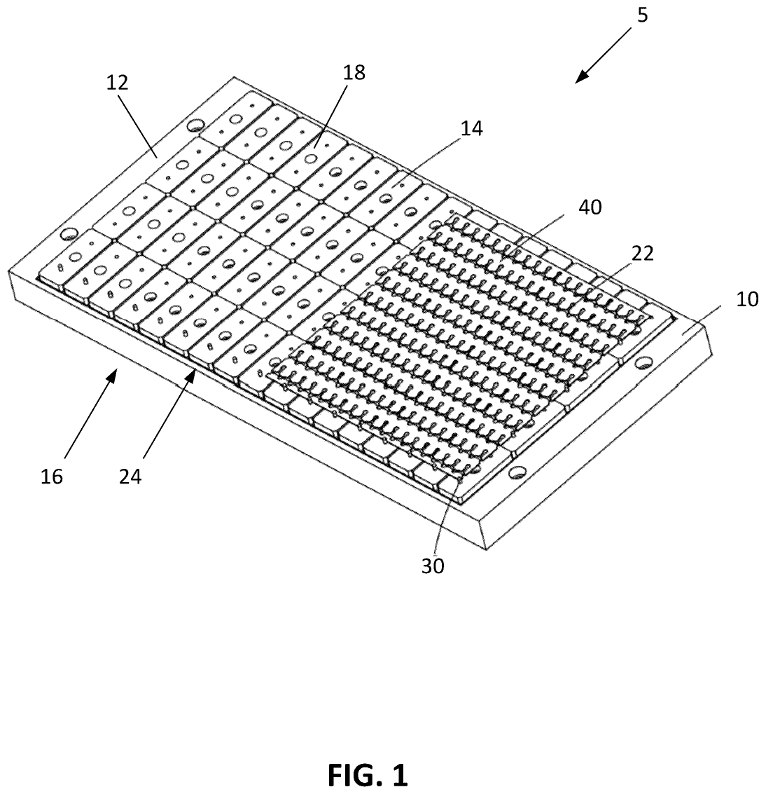

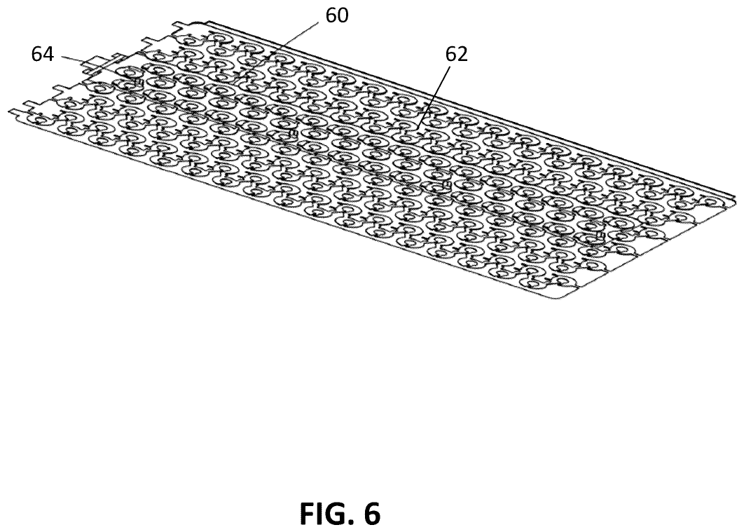

Referring to FIGS. 1-6, an embodiment of an electromagnetic bed suction cup or electromagnetic bed is illustrated. The electromagnetic bed suction cup 5 comprises an electromagnetic bed body 10 arranged horizontally, a cover plate 40 arranged correspondingly with the electromagnetic bed body 10, and a workpiece 60 held between the electromagnetic bed body 10 and the cover plate 40. The top surface 12 of the electromagnetic bed body 10 is provided with a number of magnetic guiding blocks 14, which can be referred to as magnetic conductive blocks, and a rectangular array 16 of four rows and seventeen columns is arranged between the magnetic blocks 14. It is to be understood that in different embodiments, the quantities of rows and columns of magnetic blocks can vary.

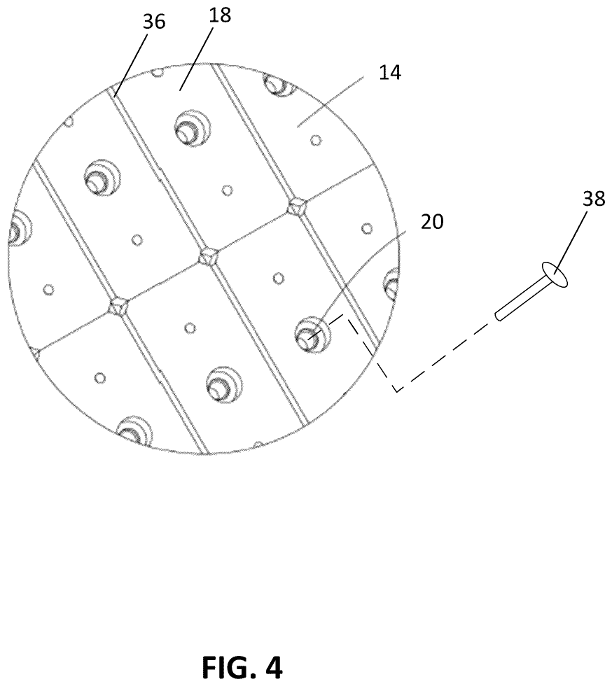

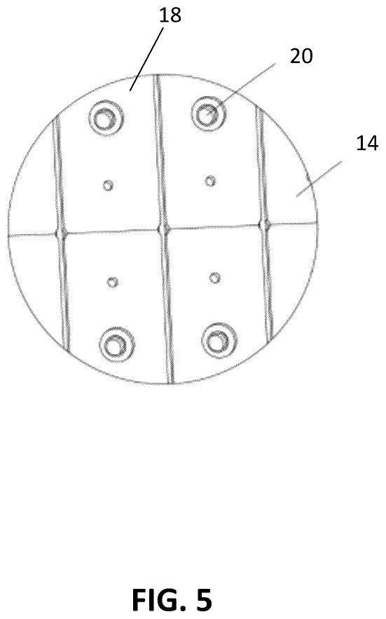

Referring to FIGS. 4 and 5, the top surface 18 of each of the magnetic blocks 14 is provided with a sunken hole 20. By connectors 38, such as bolts, (see FIG. 4), each of the corresponding magnetic blocks 14 is coupled or fixed in the electromagnetic bed body 10. Referring to FIG. 1, in this embodiment, the top surface 18 of several of the magnetic blocks 14 has a positioning pin 30 protruding therefrom. The cover plate 40 is made of magnetic material, and is concave with a number of avoidance holes 22 corresponding to the point to be welded.

In the technical scheme, the magnetic bed body 10 is fixed in the external frame or table by screws (not shown), and the magnetic force is switched by conventional technologies such as coils and control devices. The specific structure and principle and the magnetic permeability principle of the magnetic block may be any conventional technology. Each magnetic block is fixed in the magnetic bed body 10 by bolts, and the bolts are all sunk in a sink hole 20. To avoid a prominent magnetic block 14 causing interference with the workpiece 60, and in order to ensure the support of the workpiece 60, after tightening the bolt, one or more of the countersunk holes 20 can also be blocked by common devices such as caps, to avoid the welding head at the top of the countersunk hole 20 interfering with the welding. The workpiece 60 and the cover plate 40, through the corresponding positioning pin 30, are placed in turn on the top surface of the electromagnetic bed 10, and an external control device is activated to control the magnetic bed body 10 to produce a magnetic force. The cover plate 40 produces a suction force and the workpiece 60 is clamped. The avoidance hole 22 in the cover plate 40 is welded to the position, and an external welding machine is used to complete the corresponding welding process. Among them, the workpiece 60 can be a number of components that are connected together to form a full plate structure, that is, the stamping or cutting process is not completely disconnecting the cover plate and the avoidance hole and the corresponding setting. The avoidance hole can also be similar to the welding point spacing to avoid misoperation and other welding to the position. This embodiment has the advantages of a simple structure, and is used for fixing non-magnetic and thin workpieces when welding. The surface contact between the electromagnetic bed body 10 and the cover plate 40 and the workpiece 60 can fix the whole plate workpiece 60 at the same time, and improve the work efficiency.

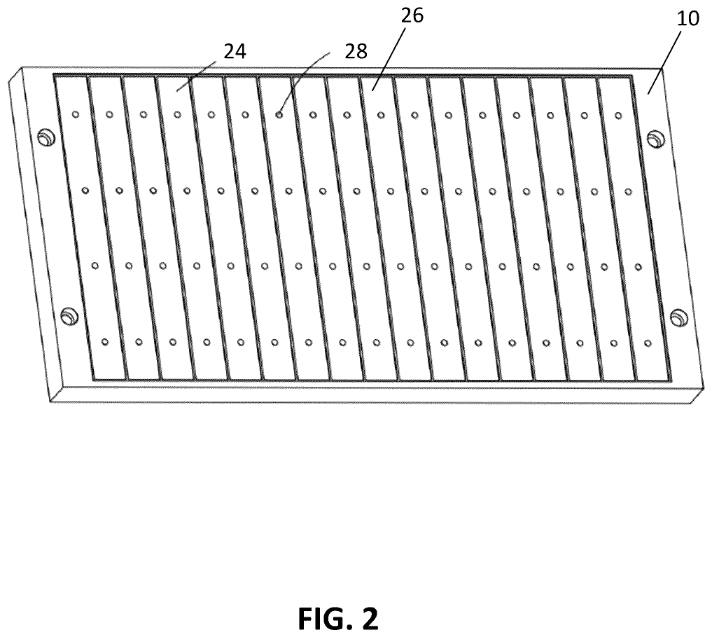

In some implementations, referring to FIGS. 1 to 5, the magnetic guide block 14 is a rectangular structure, the top surface 18 of the magnetic bed body 10 is concave with fourteen strip-like installation slots 24, the installation slots 24 are parallel and spaced, and the bottom of each of the installation slots 24 (see FIG. 2) is provided with four threaded holes 28 that corresponding to the particular magnetic guide block 14.

Referring back to FIG. 1, in one embodiment, four magnetic conductive blocks 14 are installed in each installation slot 24, and the interval between the adjacent installation slots is 3 m. The magnetic conductive blocks 14 in different installation slots 24 do not contact each other, and thus, will not interfere due to processing errors, reduce the accuracy required for processing, and facilitate assembly.

In some implementations, referring to FIGS. 4 and 5, a high chamfer of the ends and edges of each magnetic guide block 14 is set and is illustrated. In one embodiment, the edge of the magnetic block 14 that is perpendicular to the top surface 18 of the electromagnetic bed 10 is the height of the magnetic block 14, and the high chamfer of the magnetic block 14 is set. In one implementation, the chamfer is approximately a 45° equilateral chamfer or rounded corner, and a positioning slot 36 is formed between the adjacent four magnetic blocks 14, which is set corresponding to the convex or retrofitted prisms 64 on the back 62 of the workpiece 60. The workpiece 60 can be positioned without the use of positioning pins. In addition, the sides of the magnetic blocks 14 can have different grooves, by changing the position of the magnetic blocks 14 to form a different positioning slot 36, and for the positioning of the workpiece 60 to avoid a convex surface 64 of the workpiece 60, which expands the scope of the disclosed application.

In some implementations, referring to FIGS. 1-3, the positioning pin 30 is installed in a hole in each of the corresponding magnetic guide blocks 14. In different embodiments, the electromagnetic bed 10 is applied to the welding of different specifications of a workpiece 60. In some embodiments, the position and number of the corresponding positioning pins 30 are different, the positioning pins 30 can be flexibly applied, and the assembly of the pins 30 can be realized through an inserting or pulling structure, or a threaded connection structure. The specific structure and principles are not detailed or limited here.

In some implementations, referring to FIG. 1, the two adjacent sides of cover plate 40 are held against the circumferential surface of the corresponding positioning pins 30.

In one embodiment, the two adjacent sides of the cover plate 40 can be positioned by holding the corresponding positioning pins 30 at the same time. The positioning pins 30 are equivalent to the grid of the cover plate positioning, and then it can be completely fixed by holding the electromagnetic bed body 10, and the workpiece 60 is clamped.

In other implementations, the cover plate 40 is provided with a first position hole (not shown), in which a corresponding positioning pin 30 is nested.

In one embodiment, a plurality of first position holes are located around the cover plate 40, and each of the corresponding positioning pins 30 is arranged through a first position hole to realize the positioning of the cover plate 40, and improve the positioning accuracy of the cover plate 40. Then it can be completely fixed by holding by the electromagnetic bed body 10 and the workpiece 60 is clamped.

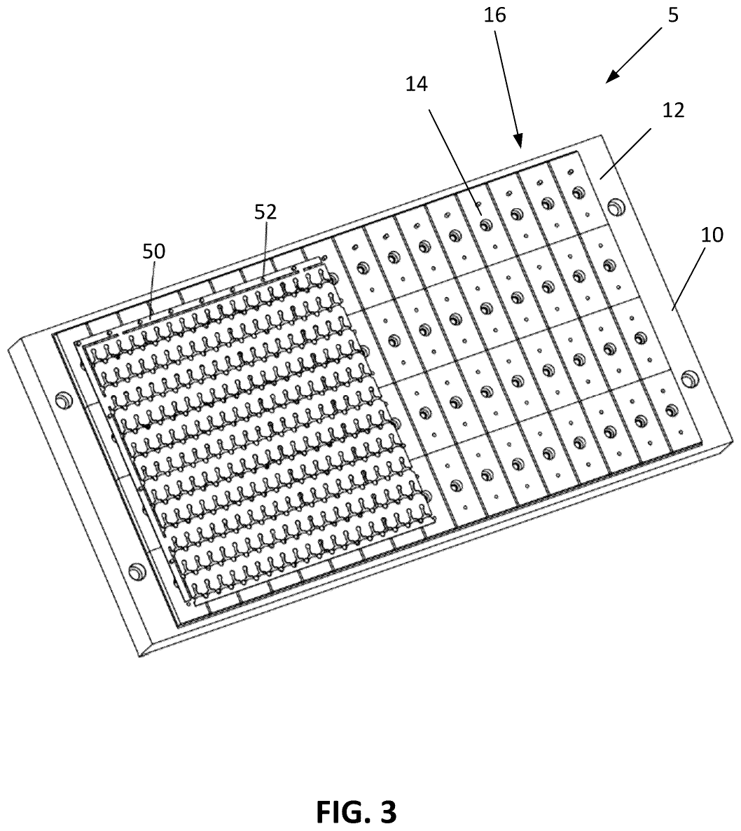

In some other implementations, as shown in FIG. 3, a positioning bar 50 is provided on the side of cover plate 40 and/or workpiece 60, and a second positioning hole 52 is provided in the positioning bar 50, which is fitted to a corresponding positioning pin 30.

In one embodiment, the positioning bar 50 is reserved during a cutting or stamping process of the cover plate 40 and/or workpiece 60, and is connected to the corresponding cover plate 40 and workpiece 60 through the connecting part. The second positioning hole 52 in the positioning bar 50 is set on a corresponding positioning pin 30, completely separating the positioning pin 30 from the processing position, avoiding problems such as dead corners in processing. In addition, compared with the grid-type positioning, the positioning accuracy is higher, thereby improving the processing accuracy. In summary, the disclosed structure has the advantages of a simple structure, and is used for fixing non-magnetic and thin workpieces when welding. The surface contact between the electromagnetic bed body 10 and the cover plate 40 and the workpiece 60 can fix the whole plate workpiece 60 at the same time, and improve the work efficiency.

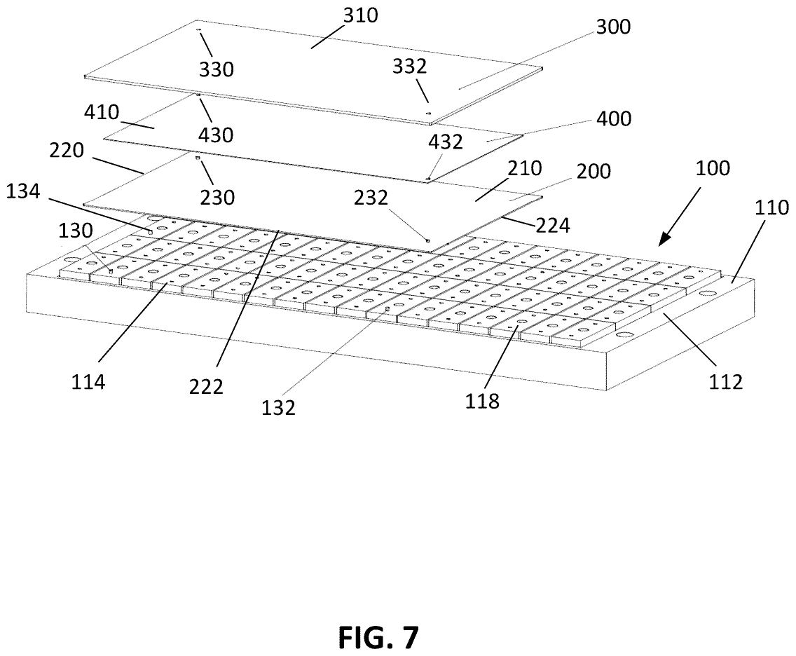

Turning to FIGS. 7-9, an alternative embodiment of an electromagnetic bed according to the present disclosure is illustrated. In this embodiment, the electromagnetic bed 100 can be used to hold a workpiece in place.

Referring initially to FIG. 7, an exploded perspective view of the electromagnetic bed 100 showing its various components is illustrated. The electromagnetic bed 100 includes an electromagnetic bed body 110, a bottom fixture plate 200, and a top cover plate 300. The electromagnetic bed body 110 has a top surface 112 and several magnetic conductive blocks 114 that collectively form a top surface 118.

To assist with positioning the bottom fixture plate 200 on the electromagnetic bed body 110, a few positioning pins are provided in spaced apart locations. In this embodiment, two positioning pins 130 and 132 are placed into holes in different ones of the conductive blocks 114 spaced apart from each other proximate to one side edge of the electromagnetic bed body 110. The positioning pins 130 and 132 extend upwardly from the conductive blocks 114 and end above the top surface 118 of the conductive blocks 114. Another positioning pin 134 is located proximate to a different side edge of the electromagnetic bed body 110.

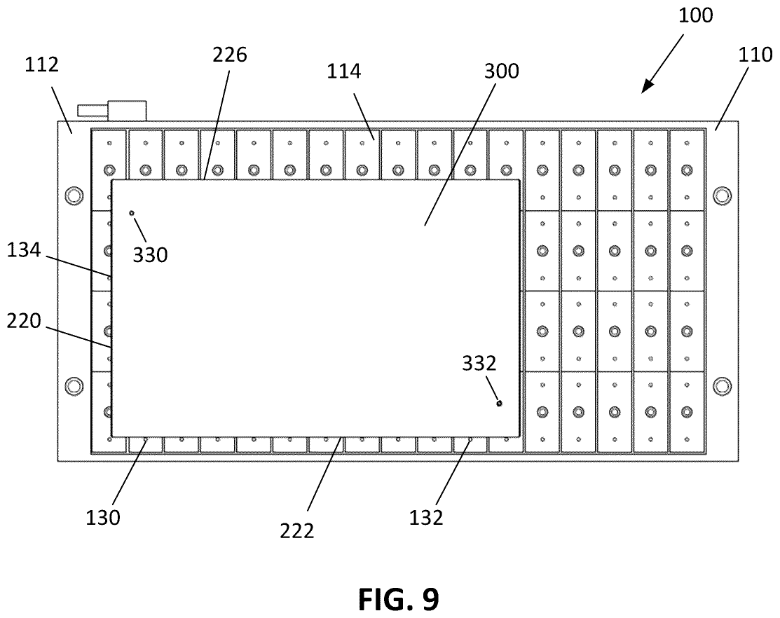

Bottom fixture plate 200 has a top surface 210 and a bottom surface opposite to the top surface 210. Bottom fixture plate 200 has side edges 220, 222, 224, and 226 (side edge 226 is illustrated in FIG. 9). In this embodiment, bottom fixture plate 200 has positioning pins 230 and 232 extending upwardly from the top surface 210. Positioning pins 230 and 232 are located near opposite corners of the bottom fixture plate 200. Bottom fixture plate 200 is made of a non-ferromagnetic material.

In this embodiment, top cover plate 300 has a top surface 310 and a bottom surface opposite to the top surface 310. Top cover plate 300 includes holes 330 and 332 that are formed in the body of the top cover plate 300 and extend between the top surface 310 and the bottom surface of the top cover plate 300. Top cover plate 300 is made of a ferromagnetic material.

The top cover plate 300 and the bottom fixture plate 200 are positioned so that a product or workpiece 400 is placed between the top cover plate 300 and the bottom fixture plate 200. When electricity is provided to the electromagnetic bed 100, the ferromagnetic material top cover plate 300 is magnetically attracted toward the electromagnetic bed body 110, which results in a product or workpiece 400 and the bottom fixture plate 200 being held in their positions.

The product or workpiece 400 has a top surface 410 and a bottom surface opposite to the top surface 410. The workpiece 400 has holes 430 and 432 formed therein that extend from the top surface 410 to the bottom surface of the workpiece 400. Holes 430 and 432 are located proximate to opposite corners of the workpiece 400.

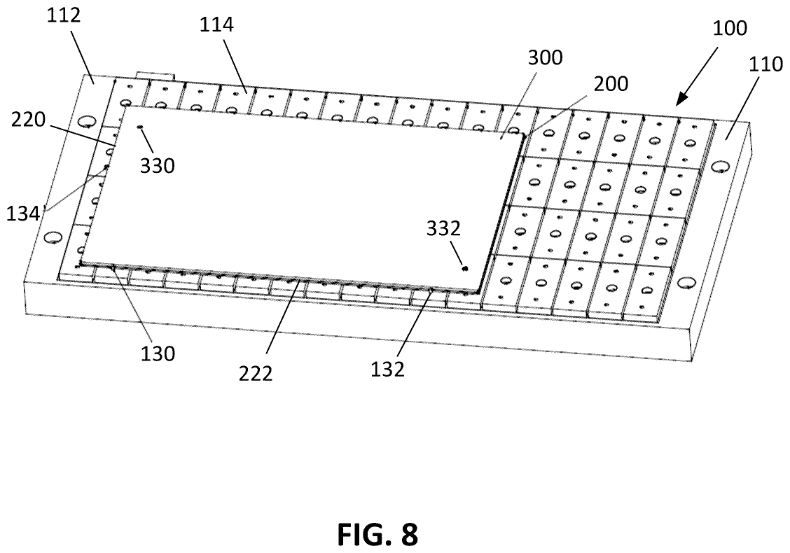

The bottom fixture plate 200 is moved to its desired position relative to the electromagnetic bed body 110, which is determined by the location of the positioning pins 130, 132, and 134. As shown in FIGS. 8 and 9, the bottom fixture plate 200 is moved so that side edge 222 abuts positioning pins 130 and 132, and side edge 220 abuts positioning pin 134. In different embodiments, the locations of positioning pins 130, 132, and 134 can be varied by inserting the positioning pins 130, 132, and 134 into different mounting holes of the magnetic conductive blocks 114, which results in the bottom fixture plate 200 being held in different positions. The positioning pins 130 and 132 constrain movement of the bottom fixture plate 200 in the Y-direction, and positioning pin 134 constrains movement of the bottom fixture plate 200 in the X-direction.

Next, the workpiece 400 is located and held in its desired position relative to the bottom fixture plate 200 by the positioning pins 230 and 232 that extend upwardly from bottom fixture plate 200. In particular, the workpiece 400 is moved so that hole 430 receives positioning pin 230 and hole 432 receives positioning pin 232. Once positioning pins 230 and 232 are located in holes 430 and 432, the workpiece 400 does not move laterally relative to the bottom fixture plate 200.

Similarly, the top cover plate 300 is located and held in its desired position relative to the workpiece 400 and the bottom fixture plate 200 by the positioning pins 230 and 232. The top cover plate 300 is moved so that hole 330 receives positioning pin 230 and hole 332 receives positioning pin 232. Once positioning pins 230 and 232 are located in the holes 330 and 332, the top cover plate 300 does not move laterally relative to the workpiece 400 and the bottom fixture plate 200.

While the top cover plate 300 and the workpiece 400 do not move laterally relative to the bottom fixture plate 200, which is located based on the positioning pins 130, 132, and 134, the top cover plate 300 is magnetically attracted toward the electromagnetic bed body 110, which holds all of the top cover plate 300, the workpiece 400, and the bottom fixture plate 200 in place and prevents vertical movement thereof.

Turning to FIGS. 8 and 9, perspective and plan views showing the top cover plate 300 holding the workpiece 400 and the bottom fixture plate 200 against the electromagnetic bed body 110 are illustrated. The bottom fixture plate 200 is proximate to magnetic conductive blocks 114. As shown, the bottom fixture plate 200 abuts positioning pins 130, 132, and 134. In particular, as shown in FIG. 9, side edge 222 abuts positioning pins 130 and 132, and side edge 220 abuts positioning pin 134.

In different embodiments, the quantity of positioning pins extending upwardly from the magnetic conductive blocks can vary. In addition, the locations of the positioning pins can vary as well, which allows for the positions of the plates 200 and 300 and the workpiece 400 to be adjusted.

It should be noted that the terms “includes”, “includes” or any other variation thereof is intended to cover non-exclusive inclusion, so that a process, method, article or device comprising a set of elements includes not only those elements but also other elements not expressly listed, as well as elements inherent to such a process, method, article or equipment. Without any further limitation, the statement “includes a . . . ” does not preclude the existence of another identical element in the process, method, article or apparatus in which the element is included.

The above description is only a specific implementation of the disclosed structure, and it should be pointed out that for ordinary technical personnel in the technical field, under the premise of not being separated from the principles of the disclosure herein, a number of improvements and refinements can be made, and these improvements and refinements should also be regarded as being within the scope of protection herein.

What is claimed is:

1. An electromagnetic bed for a workpiece, comprising:
an electromagnetic bed body that is arranged horizontally, the electromagnetic bed body having a first top surface that includes magnetic blocks that are arranged in a rectangular array, at least one of the magnetic blocks has a second top surface having a positioning pin protruding from the second top surface;
a bottom plate placed on the second top surface, the bottom plate engaging the positioning pin; and
a cover plate made of a magnetic material, wherein the workpiece can be placed between the bottom plate and the cover plate.

2. The electromagnetic bed according to claim 1, wherein the at least one of the magnetic blocks has a rectangular structure, the electromagnetic bed body is provided with a plurality of installation slots, and a bottom of each of the plurality of installation slots is provided with a plurality of threaded holes that correspond to a magnetic block located therein.

3. The electromagnetic bed according to claim 2, wherein each of the magnetic blocks has a chamfered edge.

4. The electromagnetic bed according to claim 1, wherein each positioning pin is placed into a hole in one of the magnetic blocks.

5. The electromagnetic bed according to claim 4, wherein at least one side of the bottom plate is held at its circumferential surface by one of the positioning pins.

6. The electromagnetic bed according to claim 4, wherein the bottom plate includes its own positioning pin, and the cover plate is arranged so that the positioning pin of the bottom plate extends into a hole in the cover plate.

7. The electromagnetic bed according to claim 4, wherein a positioning bar is located on a side of the cover plate or a side of the workpiece, and the positioning bar is provided with a positioning hole that can receive a positioning pin.

8. An electromagnetic bed for a workpiece, comprising:
an electromagnetic bed body having a top surface that includes a plurality of magnetic blocks, each of the plurality of magnetic blocks has its own top surface, at least two of the magnetic blocks include a positioning pin protruding therefrom, each of the plurality of magnetic blocks being coupled to the electromagnetic bed body;
a bottom plate placed on the top surfaces of the magnetic blocks, the bottom plate engaging the positioning pin protruding from the magnetic blocks; and
a cover plate made of a magnetic material, wherein the workpiece can be placed between the bottom plate and the cover plate.

9. The electromagnetic bed according to claim 8, wherein the electromagnetic bed body has a plurality of installation slots, each of the plurality of installation slots receiving at least one magnetic block, and a bottom of each of the plurality of installation slots has at least one hole that corresponds to a magnetic block located therein and that can be used to couple a magnetic body to the electromagnetic bed body.

10. The electromagnetic bed according to claim 8, wherein the bottom plate is made of a non-magnetic material.

11. The electromagnetic bed according to claim 8, wherein each of the plurality of magnetic blocks has a chamfered edge.

12. The electromagnetic bed according to claim 8, wherein the top surface of each of the plurality of magnetic blocks has a hole, and each positioning pin is placed into a hole in the top surface of one of the plurality of magnetic blocks.

13. The electromagnetic bed according to claim 12, wherein at least one side of the bottom plate is held at its circumferential surface by one of the positioning pins.

14. The electromagnetic bed according to claim 12, wherein the bottom plate includes its own positioning pin, and the cover plate is arranged so that the positioning pin of the bottom plate extends into a hole in the cover plate.

15. The electromagnetic bed according to claim 12, wherein a positioning bar is located on a side of the cover plate or a side of the workpiece, and the positioning bar is provided with a positioning hole that can receive a positioning pin.

16. An electromagnetic bed for a workpiece, comprising:
an electromagnetic bed body having a top surface that includes a plurality of magnetic blocks, the electromagnetic bed body has a plurality of installation slots, each of the plurality of installation slots receiving at least one magnetic block, at least two of the plurality of magnetic blocks has its own top surface that has a positioning pin protruding therefrom, each of the plurality of magnetic blocks being coupled to the electromagnetic bed body;
a bottom plate positioned proximate to the top surfaces of the magnetic blocks; and
a cover plate made of a magnetic material, wherein the workpiece can be placed between the bottom plate and the cover plate, and the cover plate is drawn to the electromagnetic bed body to hold the workpiece and the bottom plate in place.

17. The electromagnetic bed according to claim 16, wherein a bottom of each of the plurality of installation slots has at least one hole that corresponds to a magnetic block located therein and that can be used to couple one of the plurality of magnetic blocks to the electromagnetic bed body.

18. The electromagnetic bed according to claim 16, wherein the bottom plate is made of a non-magnetic material.

19. The electromagnetic bed according to claim 16, wherein the top surface of at least two of the plurality of magnetic blocks has a hole, and a positioning pin is placed into the hole in the top surface of at least two of the plurality of magnetic blocks.

20. The electromagnetic bed according to claim 19, wherein at least one side of the bottom plate is held at its circumferential surface by one of the positioning pins.
